(19) United States
(12) Patent Application Publication
(10) Pub. No.: US 2023/0050525 A1
(43) Pub. Date: Feb. 16, 2023

(54) SYSTEMS AND METHODS FOR CONTROLLING ACCESS TO A DATABASE

(71) Applicant: Braze, Inc., New York, NY (US)

(72) Inventors: Jonathan HYMAN, New York, NY (US); Zachary MCCORMICK, New York, NY (US)

(21) Appl. No.: 17/400,700

(22) Filed: Aug. 12, 2021

(51) Int. Cl. G06F 21/62; G06F 16/2455

(52) U.S. Cl. CPC G06F 21/6218; G06F 16/24564

(57) ABSTRACT

Systems and methods for throttling requests submitted to a database are designed to maximize the rate at which information can be obtained from the database. In the throttling methods, the time required for the database to perform a certain operation is monitored. If the time required to perform the operation exceeds a threshold time period, a request limit is imposed on the database, the request limit limiting the number of data read and/or write requests that can be submitted to the database per unit of time.

### BACKGROUND OF THE INVENTION

The invention is related to systems and methods for controlling access to databases to preserve the operational efficiency of the databases. More specifically, the invention is related to systems and methods for throttling read or write requests submitted to a database to help prevent the database from being overwhelmed by a large number of requests per unit of time.

Systems and methods embodying the invention can be utilized by a customer engagement service. A customer engagement service helps a client company interact with its customers or users to enhance the customer experience and to increase the company's business, revenue and/or stature. One of the ways that a customer engagement service assists a client company is by helping the company to manage how and when messages are delivered to the company's customers or users.

The following description refers to “clients” and to “users”. For purposes of this discussion, a “client” would be a client of the customer engagement service. In other words, a company or business that is being assisted by the customer engagement service in delivering messaging to the client company's customers or users. “Users” are a client's customers or users, not users of the customer engagement service. The customer engagement service sits between a client and the client's users to manage and orchestrate the delivery of messages sent from the client to its users.

When a customer engagement service receives a request from one of its clients to send a particular message to the client's users, the customer engagement service will often generate and send personalized messages to all or selected ones of the client's users. In order to personalize a message, it is necessary for the customer engagement service to obtain personal information about each of the client's users that are to receive the message. Also, it is usually necessary for the customer engagement service to obtain user address information that allows the message to be delivered directly to the users. For example, if the message is to be delivered to users via email, it would be necessary for the customer engagement service to obtain the email address for each user that is to receive the message. If the message is to be delivered via a text message, it would be necessary for the customer engagement service to obtain the telephone numbers or text messaging addresses of the client company's users. Thus, the term “address information” is intended to encompass many different forms of address information that can be used to deliver a message to a user via any of multiple different message delivery mechanisms.

User personalization information and user address information is typically obtained from one or more customer databases. In many instances, the customer engagement service will maintain a separate database of user information for each client of the customer engagement service. In some instances, the customer engagement service may maintain multiple databases of user information for each client, with each database storing a different type of user information. Also, in some instances, the customer engagement service may store user information for multiple clients in a single database.

When it is time to generate and send a message to all or selected ones of a client's users, the customer engagement service queries one or more databases of the client's user information to obtain personalization information and address information for the users who are to receive the message. The obtained information is then used to generate and send the message to the client's users. Also, in many instances, information about the message that is sent to users and/or the date and time at which each copy of the message is sent to a user is recorded in the user information databases either before or after each message is sent to a user.

If the message is to be sent to only a small number of users, typically only one or only a few servers will be engaged in the tasks of obtaining user personalization and address information from a user information database, generating and sending the message to those users, and recording information about the messages that were sent in the user information database. However, when the message is to be sent to a large number of users, a large number of servers may be engaged in those tasks. The customer engagement service has flexibility in the number of servers that can be employed to accomplish those tasks, making it easy for the customer engagement service to rapidly scale up its capacity to deliver a message to a large number of users in a relatively short period of time.

FIG. 1 illustrates a situation where multiple servers 110A-11OG are querying four different client databases of user information 112A-112D to obtain personalization information and address information in order to generate and send four different messages to the users of four different client companies, and possibly also to record information about the messages that were sent in those user information databases. In this example, each of the four messages are being sent to a small or medium number of users.

As illustrated, server 110A is querying a first client's database of user information 112A to obtain personalization and address information for the first client's users in order to send a first message to a relatively small number of the first client's users. The server 110A may also record information about the messages that are sent to users in the first client's database of user information 112A. Because the message is to be delivered to only a relatively small number of users, only a single server 110A is tasked with querying the first client's database of user information 112A, generating and sending the first message to the first client's users, and recording information about the messages that are sent in the first client's database of user information 112A.

Servers 110B and 110C are querying a second client's database of user information 112A to obtain personalization and address information for the second client's users in order to send a second message to a small to medium number of the second client's users. The servers 110B and 110C may also record information about the messages that are sent to users in the second client's database of user information 112B. Because the message is to be delivered to only a small to medium number of users, only two servers 110B/110C are tasked with querying the second client's database of user information 112B, generating and sending the second message to the second client's users, and recording information about the messages that are sent in the second client's database of user information 112B.

Servers 110D and 110E are querying a third client's database of user information 112C to obtain personalization and address information for the third client's users in order to send a third message to a small to medium number of the third client's users. The servers 110D and 110E may also record information about the messages that are sent to users in the third client's database of user information 112C. Because the message is to be delivered to only a small to medium number of users, only two servers 110D/110E are tasked with querying the third client's database of user information 112C, generating and sending the third message to the third client's users, and recording information about the messages that are sent in the third client's database of user information 112C.

Servers 110F and 110G are querying a fourth client's database of user information 112D to obtain personalization and address information for the fourth client's users in order to send a fourth message to a medium number of the fourth client's users. The servers 110F and 110G may also record information about the messages that are sent to users in the fourth client's database of user information 112D. Because the message is to be delivered to only a small to medium number of users, only two servers 110F/110G are tasked with querying the fourth client's database of user information 112D, generating and sending the fourth message to the fourth client's users, and recording information about the messages that are sent in the fourth client's database of user information 112D.

In the scenario depicted in FIG. 1, the databases of user information 112A-112D are not likely to become overloaded with more data read and data write requests per unit of time than they can efficiently support because, at most, only two servers are sending data read and write requests to a single database. As a result, we would expect the databases to respond to data read and write requests fairly rapidly, making it possible for the servers to rapidly generate and send messages to the clients' users.

FIG. 2 depicts a different scenario. The situation remains unchanged with respect to the second, third and fourth messages being sent, respectively, to the second, third and fourth client's users. However, a first message is now being sent to a large number of the first client's users. As a result, the customer engagement service has scaled up to use four servers 110A, 110H, 110I and 110J to query the first client's database of user information 112A, to generate and send the first message to the large number of the first client's users, and to record information about the messages that are sent in the first client's database of user information 112A. Because four servers 110A, 110H, 110I and 110J are now sending read and write requests to the first client's database of user information 112A, the first client's database of user information 112A may be at risk of being overwhelmed by a large number of data read and/or write requests per unit of time. If that occurs, the usual result is that the database takes longer to respond to each individual data read and write request than would normally be the case. The slower database response time, in turn, slows the rate at which copies of the first message can be generated and sent to the first client's users.

Applicant notes that the depictions in FIGS. 1 and 2, and the foregoing description, are intended to illustrate the concept of what can occur when too many data requests and/or too many write operations are submitted to a database per unit of time. In a real-world scenario, a single database may be capable of responding to queries or data requests sent from a much larger number of servers without significant degradation in response time performance. Indeed, a single database may be capable of efficiently responding to data queries or write requests for tens or even one hundred or more servers within a short period of time without significant degradation in response time performance. Thus, the depictions in FIGS. 1 and 2, and the foregoing description, which involve only a limited number of servers, should in no way be considered limiting of the invention.

### BRIEF DESCRIPTION OF THE DRAWINGS

FIG. 1 is a diagram illustrating how multiple servers may query databases of user information.

FIG. 2 illustrates how multiple servers may query databases of user information, with one database of user information becoming overloaded by too many data requests per unit of time.

FIG. 3 is a diagram of a communications environment which could be utilized by systems and methods embodying the invention.

FIG. 4 is a diagram of selected elements of a customer engagement service embodying the invention.

FIG. 5 is a graph illustrating how the amount of time that database requires to respond to a read request varies as the number of read requests per unit of time that are submitted to the database varies. FIG. 5 also illustrates how the database's total number of generated responses per unit of time varies as the number of read requests per unit of time submitted to the database varies.

FIG. 6 is a diagram illustrating selected elements of a database query throttling unit embodying the invention that may be part of a customer engagement service.

FIG. 7 is a diagram illustrating steps of a first method embodying the invention for throttling requests being submitted to a database.

FIG. 8 is a diagram illustrating steps of a second method embodying the invention for throttling requests being submitted to a database.

FIG. 9 is a diagram illustrating steps of a third method embodying the invention for throttling requests being submitted to a database.

FIG. 10 is a diagram illustrating steps of a fourth method embodying the invention for throttling requests being submitted to a database.

FIG. 11 is a diagram illustrating steps of a fifth method embodying the invention for throttling requests being submitted to a database.

FIG. 12 is a diagram illustrating steps of a sixth method embodying the invention for throttling requests being submitted to a database.

FIG. 13 is a diagram illustrating steps of a seventh method embodying the invention for throttling requests being submitted to a database.

FIG. 14 is a diagram of a computer system and associated peripherals which could embody the invention, or which could be used to practice methods embodying the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

As mentioned above, systems and methods embodying the invention can be a part of a customer engagement service, which assists a client company in delivering messages to the client company's users. Such a “message” could take many different forms and be delivered to users in different ways.

For example, a “message” could be a mobile or browser-based push notification sent to users by a push notification service. Such a push notification could be delivered to the operating system of a user's smartphone or computing device.

A message could also be an in-app message that is delivered to a user via a client's software application. The client's software application could be resident on a user's computer, a user's smartphone or any other device with a processor that is capable of running such a software application. The in-app messages generated and/or delivered by such a software application could be received by the user in various ways.

A message also could be a text message (SMS/MMS) that is delivered to users via a smartphone or via a text messaging software application. A message also could be a message delivered to a user via a social media service, or via an Over The Top (OTT) messaging service. A message also could be an email message that is delivered to users via standard email service providers. Moreover, a message could be an audio message delivered to a user via a telephony or VOIP service provider, or a video message delivered via similar means.

For purposes of the following description and the appended claims, any reference to sending a “message” to users is intended to encompass any of the different types of messages and delivery channels mentioned above, as well as any message types and delivery means that are developed in the future.

A customer engagement service can also help a client to conduct a multi-message advertising effort, marketing effort or informational effort by sending multiple messages to a user over a period of time. During such a multi-message effort, the customer engagement service can help to ensure that the messages are delivered according to a certain sequence, and/or according to a certain timing and/or in response to the occurrence of various events. For example, the customer engagement service can help to ensure that a second message of a multi-message effort is not sent to a user until the user has reviewed a first message of the multi-message effort. Similarly, a multi-message effort might be structured such that a third message is not sent to a user unless the user first takes a specified action, such as making a purchase from the client who requested the multi-message effort.

There are many ways that multi-message efforts can be conducted or structured, the foregoing outlined only two examples. Often, during a multi-message effort a message trigger must be satisfied before a certain message is sent to a user. The message trigger can be an action taken by the user, the occurrence of an event, or some other trigger condition being satisfied.

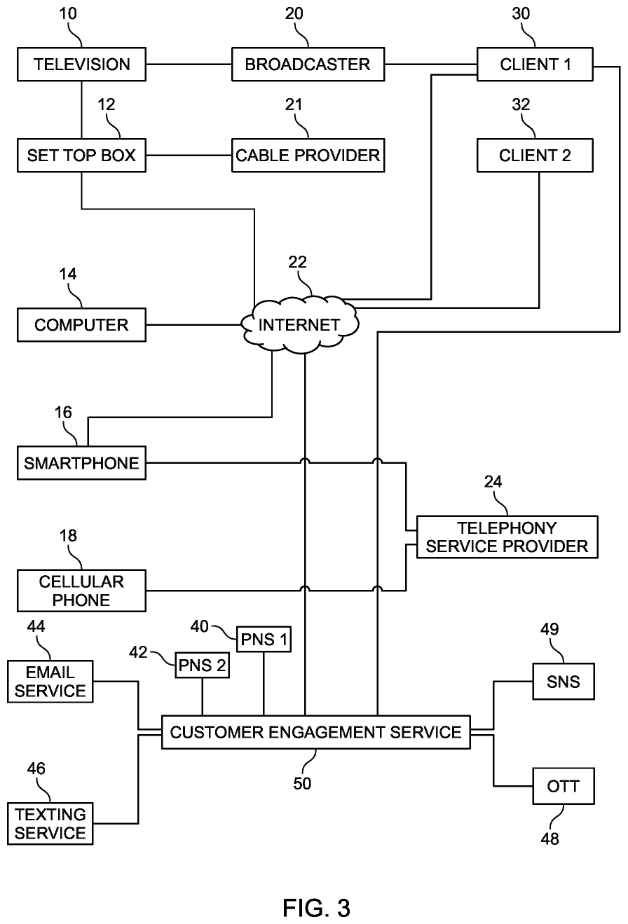

FIG. 3 illustrates a communications environment in which systems and methods embodying the invention could be practiced. As shown in FIG. 3, the communications environment includes client one 30, client two 32 and the customer engagement service 50. Client one 30 and client two 32 are clients of the customer engagement service 50. The clients 30/32 can communicate with the customer engagement service directly, via the Internet 22, or via other means.

Users of the clients 30/32 could utilize the clients' 30/32 services in various ways. For example, if client one 30 is a media company that provides media content to its users, client one 30 could produce media content that is sent via a broadcaster 20 to a client's television 10. That media content could be delivered to the user's television 10 via a set top box 12 that is connected to the user's television and to the Internet 22 and/or a cable service provider 21. In some instances, a software application on the set top box 12 that is provided by client one 30 could be used to deliver the content to the user's television 10.

The same or a different user might have a computer 14 that is connected to the Internet 22. The user could utilize a web browser on the computer 14 to access an Internet website provided by client one 30 that also offers media content. Similarly, a software application provided by client one 30 and that is resident on the user's computer 14 might also be used to access media content provided by client one 30 via the Internet 22.

Yet another user may have a smartphone 16 that is capable of communicating over the Internet 22 and/or via a telephony service provider 24. A software application provided by client one 30 and that is resident on the user's smartphone 16 could be used to access media content provided by client one 30 via the Internet 22 or via the telephony service provider 24.

Still another user might have a cellular telephone 18 that is capable of receiving text messages. This would allow the user of the cellular telephone to receive text messages from client one 30.

FIG. 3 also shows that a first push notification service (PNS) 40 and a second push notification service 42 could be used by the customer engagement service 50 to deliver push notifications to smartphones and/or web browsers. Such messages could be delivered by the push notification services 40/42 to user smartphones via the Internet 22 or via a telephony service provider 24 that provides user smartphones with its native telephony service.

FIG. 3 also shows that an email delivery service 44 could be used by the customer engagement service 50 to send email messages to users. Further, the customer engagement service 50 could use a text messaging service 46 to send text messages to users, or an OTT messaging service 48 to send formatted messages to users. Moreover, the customer engagement service 50 might send a message to users via one or more social networking services 49. Of course, the customer engagement service 50 could utilize any other message delivery service as well to communicate messages to users.

The clients 30/32 in this communications environment could be any sort of client that utilizes a customer engagement service 50 to help them manage engagement with their users. As noted above, a client could be a media broadcaster that produces and sends media content to its users. In other instances, a client could be a retailer whose purchasers are its users. In still other instances, the client could be a service provider, such as a telephony service provider or an Internet service provider. Virtually any business that wishes to send messages to its users or conduct advertising or informational campaigns could be a client in this environment.

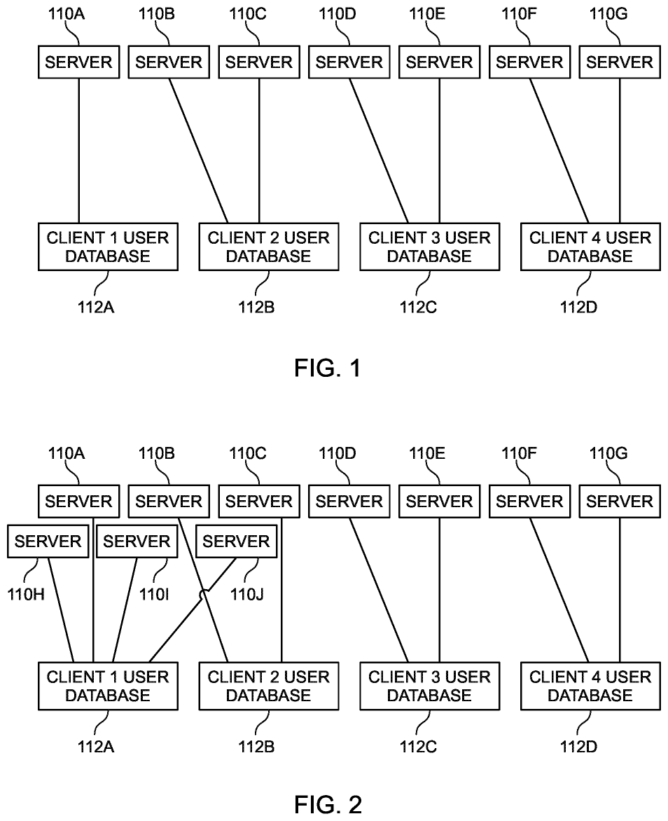

One of skill in the art will appreciate that FIG. 3 only illustrates a very limited number of devices that would be used by users to receive messages from a client, and that could be used to interact with a client. In reality, there would be a very large number of user devices in such a communications environment. Also, a single user could possess and use multiple devices to access a client's services and to receive messages from a client. Thus, the depiction in FIG. 1 should in no way be considered limiting.

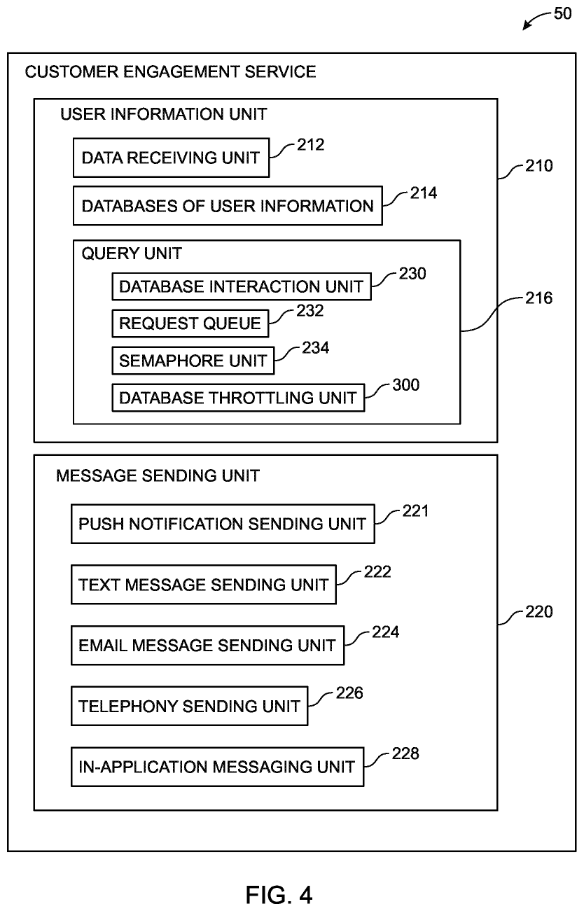

FIG. 4 illustrates selected elements of a customer engagement service 50. The illustration in FIG. 2 is in no way intended to show all elements of a typical customer engagement service 50, and indeed there would typically be many other elements. Likewise, a customer engagement service 50 embodying the invention might not have all the elements illustrated in FIG. 4.

The customer engagement service 50 includes a user information unit 210 that is responsible for receiving and storing information about a client's users, and that is responsible for responding to requests for that stored information. The user information unit 210 includes a data receiving unit 212 that receives various items of information about users, and stores that received information in databases 214. The information could be received from various sources. However, typically a client would provide information about its users to the data receiving unit 212 via various means.

For example, in some instances a client may send notifications to the data receiving unit 212 each time that one of the client's users engages with the client in some fashion. If the client is an online retailer, each time that a user makes a purchase from the online retailer, the online retailer could send the data about the purchase made by that client to the data receiving unit 212.

In another example, if the client is a media broadcaster, and one of the media broadcaster's users logs onto a website provided by the media broadcaster to access media content, the media broadcaster could send data about that contact to the data receiving unit 212. The data sent could include an identification of the user, the time that the user accessed the website and an indication of what the user accessed or watched while logged into the website. Similarly, any time that a user accesses a client's website, the client could automatically report that user activity to the data receiving unit 212 of the customer engagement service 50.

In yet another example where the client is a media broadcaster, the media broadcaster could have provided a software application to a user that the user has loaded onto a smartphone or a computing device. The software application could be configured to report the actions that a user takes when using the software application directly to the data receiving unit 212 of a customer engagement service 50. Indeed, in any instance where the client has provided a software application to its users, the software application could be configured to report user activity to the data receiving unit 212 of the customer engagement service 50.

Because clients and software applications that the clients provide to their users all report user activity to the customer engagement service 50, the customer engagement service 50 is able to build a detailed picture of each user, the user's preferences, and the user's typical courses of action.

In addition, because the customer engagement service 50 is tasked by its client with the delivery of messages to the client's users, the customer engagement service 50 is also able to build up a record of how and when individual users react to a sent message. This could include an indication of when a user opens a sent message after delivery, and whether and when the user takes an action in response to receipt of a message. For example, because the data receiving unit 212 is also receiving information from the client regarding user contacts with the client, the customer engagement service 50 may learn that shortly after an individual user received a message from the client, the user logged into the client's website. Or that shortly after the user received a message, the user opened a software application provided by the client. For all these reasons, the customer engagement service 50 is able to build detailed user profiles that can be used to predict how individual users will act in certain situations, or how they will respond to certain forms of messaging.

As shown in FIG. 4, the user information unit 210 also includes a query unit 216. The query unit 216 queries databases of user information 214 to obtain various items of information about the users, such as personalization information and user address information.

The query unit 216 includes a database interaction unit 230 that is configured to query the databases of user information 214 to obtain information that is used to generate and send messages to a client's users. The database interaction unit 230 may also operate to cause information to be written into user databases to record certain information. For example, when the customer engagement service 50 is sending a particular message to a client's users, the database interaction unit 230 may first query a database of user information 214 to obtain personalization information and address information needed to deliver the message to a particular user. When a message has been prepared for that user using the acquired information, the database interaction unit 230 may record in the user information database 214 information about the message and/or information about when the message was sent to the user just before or just after the message is actually sent. Thus, the database interaction unit 230 may both obtain information from and write information to the databases of user information 214.

The database interaction unit 230 may direct the actions of servers that actually perform the processes of: (1) querying a database of user information 214 for personalization and address information; (2) using that information to generate and send messages to a client's users; and (3) writing information to the database regarding what messages were sent, and when the messages were sent. As mentioned above, when a message is to be sent to only a limited number of a client's users, the database interaction unit 230 may only employ and direct the actions of one or a few servers to accomplish these tasks. However, when a message is to be sent to a large number of a client's users, the database interaction unit 230 may employ a large number of servers to accomplish these tasks. This makes it possible for the database interaction unit 230 to increase the capabilities and capacity of the customer engagement service 50 as necessary to efficiently and rapidly send personalized messages to a large number of a client's users.

As mentioned in the Background Section above, when too many requests for data are submitted to a database per unit of time, the database may become slow to respond to each individual data request. For example, when a database is under a light data request load, and it receives only one data request each second, the database may respond to the data request within 100 milliseconds. If the data request load increases to ten data requests each second, we would hope that the database would continue to respond to each individual data request within 100 milliseconds. Indeed, most databases are capable of operating with this type of responsiveness. However, if the number of data requests per unit of time continues to increase, there likely will come a time when the database is unable to respond to each individual data request within the same 100 milliseconds. For example, if the number of data requests increases to 100 data requests per second, we might see the database response time lengthen such that the database requires 200 milliseconds to respond to each individual data request.

A similar situation exists with respect to requests to write data to a database. When a database is receiving only a few requests to write data to the database each second, the database may be capable of reliably accomplishing each write task within a certain period of time. However, when a large number of requests to write data to the database are received each second, the database may require a longer period of time to accomplish each individual write task. Indeed, because a database typically requires a longer period of time to accomplish a write task than it does to accomplish a read task, the database may be more sensitive to becoming overloaded when it receives a large number of write requests per unit of time than when it receives a large number of read tasks per unit of time.

The fact that a database of user information exhibits slowed performance when the database is receiving a large number of read/write requests per unit of time has real world consequences for a customer engagement service that is attempting to send a message to a large number of a client's users. For example, if the customer engagement service is sending a message to a small number of a client's users, a few servers under the direction of the database interaction unit 230 will be sending only a relatively small number of data read/write requests per unit of time to the client's user information database 214. Under this light load, the database of user information 214 will be able to respond quickly to each individual data read/write request. As a result, the servers will be able to send copies of the message to the client's users at a relatively high rate of messages per unit of time.

However, if a message is to be sent to a large number of a client's users, the database interaction unit 230 may employ a large number of servers to prepare and send the message to the client's users. Because a large number of servers are engaged in this process, the database of user information may receive a large number of data read/write requests per unit of time. As explained above, this can result in the database taking longer than normal to respond to each individual data read or write request. The end result is that even though a large number of servers have been engaged to send the message to the client's users, the database's ability to quickly respond to read and write requests ends up slowing the ability of the customer engagement service to send copies of the message to the client's users. Ironically, the rate at which copies of the message are sent to the client's users per unit of time actually decreases relative to the message send rate that can be achieved when the database of user information is receiving a lesser number of data read/write requests per unit of time.

The inventors have developed systems and methods that are designed to ensure that the rate at which messages can be sent to a client's users, in other words the number of messages that are sent per unit of time, is kept high even in situations where a large number of servers are submitting data read/write requests to the client's database of user information. This is achieved by controlling the number of data read/write requests that are submitted to the database per unit of time to achieve a desirably high message sending rate.

In the systems and methods developed by the inventors, the time a database takes to perform read and/or write tasks is monitored to determine if the time the database requires to accomplish each individual read and/or write operation has become longer than one or more threshold values. As will be explained below, the threshold values are typically slightly longer than the most efficient speeds at which the database can respond to read/write requests. Also, the threshold values are selected in an effort to maximize the message send rate.

If the time that the database requires to perform a read and/or write operation is greater than a threshold value, throttling is applied to reduce or limit the number of read and/or write requests that are submitted to the database per unit of time. The time the database requires to accomplish read and/or write operations is then monitored after throttling has been applied. If reducing the number of read/write requests that are submitted to the database per unit of time results in an increase in the overall message sending rate, the throttling is maintained.

If a first degree of throttling is not successful in increasing the message sending rate, a greater degree of throttling can be applied to further reduce the number of read/write requests that are submitted to the database per unit of time. The aim being to decrease the amount of time that the database requires to respond to each individual read/write request. Likewise, if a first degree of throttling has been applied, and the database thereafter gets to the point where it is rapidly processing each read/write request, the degree of throttling that has been applied can be relaxed, allowing a greater number of read/write requests per unit of time to be submitted to the database. The goal is to selectively vary the degree of throttling that is applied to keep the overall message sending rate acceptably high.

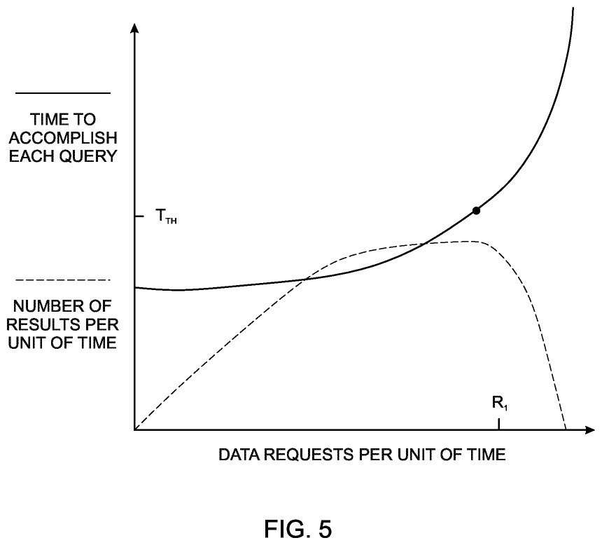

FIG. 5 shows a graph which helps to illustrate how the amount of time that a database requires to respond to a data read request varies as the number of data read requests per unit of time that are submitted to the database varies. There are two lines plotted in FIG. 5. First, there is a solid line that illustrates how the time that a database requires to process an individual data read request increases as the number of data read requests per unit of time that are submitted to the database increases. FIG. 5 also includes a dashed line that indicates the total number of responses to data read requests that the database can provide per unit of time as the number of data read requests per unit of time that are submitted to the database increases.

As is evident in FIG. 5, as the number of data read requests per unit of time that are submitted to the database increases, the time required for the database to respond to each individual data read request increases. The increase in the time required to respond to each individual data read request follows a generally exponential curve.

As is also evident in FIG. 5, as the number of read requests submitted to the database per unit of time increases, the total number of responses that the database can provide per unit of time increases up to a point. However, because of the exponential way that the time required for the database to respond to each individual data read request increases, there comes a point at which the number of responses that the database can provide per unit of time begins to fall off.

It is the dashed line in FIG. 5, representing the number of data read requests responses per unit of time that the database can provide, that corresponds to the rate at which the customer engagement service can send messages to a client's users. Thus, we would only apply throttling to limit the number of data read requests submitted to the database per unit of time to prevent the response rate of the database from significantly falling off. As can be seen in FIG. 5, the number of responses that the database can provide per unit of time begins to fall off significantly when the number of data read requests submitted to the database per unit of time exceeds rate R₁. As can also be seen in FIG. 5, this corresponds to the point at which the time required for the database to accomplish each data read request is above threshold time period T_{TH}. In order to ensure that the customer engagement service can send messages to a client's users at a high rate of messages per unit of time, it is necessary to limit the number of data read requests submitted to the database per unit of time to be rate R₁ or less. One way to achieve this is to begin limiting the number of data read requests submitted to the database per unit of time when the time required for the database to respond to an individual read request exceeds threshold time T_{TH}.

With the above concepts in mind, it is possible to use various different mechanisms to decide when and how to apply throttling to help preserve the rate at which a customer engagement service can send messages to a client's users.

One way to control throttling is to monitor the time required for the database to respond to each individual data read request. If the time that the database requires to respond to a data read request exceeds threshold time period Tₜₕ, then throttling is applied to limit or cap the number of data read requests that are submitted to the database per unit of time. This helps to ensure that the database is able to respond to a fairly large number of data read requests per unit of time, which in turn ensures the customer engagement service can send a large number of messages to a client's users per unit of time.

It might also be possible to monitor the total number of messages per unit of time that the customer engagement service is sending to a client's users. The total number of messages sent to users per unit of time correlates to the total number of responses per unit of time that the database can provide. However, monitoring the total number of messages that are sent to users per unit of time can be difficult because it often requires monitoring the actions of multiple servers that are engaged in this effort. Also, there could be delays in the servers sending messages that are caused by factors unrelated to the database read request response time. For these reasons, it is preferable to simply monitor the time required for the database to respond to individual data read requests, and to base throttling on that measure.

Applicant notes that it is also possible to monitor the time required for the database to respond to individual data write requests, and to base throttling on that measure. The time required for the database to respond to individual write requests is also indicative of whether the database is becoming overloaded by too many data read/write requests per unit of time.

Moreover, it is also possible to monitor both the time required for the database to respond to individual read requests and the time required for the database to respond to individual write requests, and to base throttling on both of those measures. Again, the goal is to ensure that the database is able to provide the maximum number of responses per unit of time, which in turn allows the customer engagement service to send the maximum number of messages to a client's users per unit of time.

With the above explanation, we will now turn to an explanation of the elements of the query unit 216 that are used to apply and relax throttling of data read/write requests being submitted to a database. The query unit 216 includes a request queue 232, which can be used to queue up data read and write requests that are to be submitted to a database of user information by multiple servers. In some embodiments, the request queue 232 can be one or more first-in first-out buffers for delivering data read requests and data write requests to the database of user information. Thus, the request queue 232 can include a first data read request queue that is a queue of data read requests submitted by servers attempting to obtain information from a database of user information in order to prepare and send messages to individual users. The request queue 232 can also include a data write request queue that is a queue of data write requests submitted by servers that are about to send a message to a user, or that have just sent a message to a user. A data write request typically would be a request to record information about a message sent to an individual user, and/or information about the time at which such a message was sent to an individual user. The actions of the request queue 232 in throttling data read/write requests submitted to a database of user information is discussed in more detail below.

The query unit 216 further includes a semaphore unit 234 which is configured to help control the rate at which data read and write requests are submitted to a database of user information. The semaphore unit 234 helps to track the available capacity of a database of user information to respond to data read and write requests. The actions of the semaphore unit 234 in throttling the rate at which data read/write requests are submitted to a database of user information is discussed in more detail below.

The query unit 216 also includes a database throttling unit 300 that is configured to limit the rate at which data read and/or data write requests are submitted to a database of user information. In some embodiments, the database throttling unit 300 is able to separately control the number of data read requests that are submitted to a database per unit of time and the number of data write requests that are submitted to the database per unit of time. The database throttling unit 300 can utilize the query queue 232 and the semaphore unit 234 to help impose limits on the number of data read/write requests that are submitted to a database of user information per unit of time. The actions of the database throttling unit 300 in a process of throttling data read/write requests is discussed in more detail below.

The customer engagement service 50 also includes a message sending unit 220. The message sending unit 220 is responsible for sending messages to a client's users. As explained above, messages could take many different forms and have many different delivery channels. The message sending unit 220 includes a push notification sending unit 221 that causes mobile or browser-based push notifications to be sent to users via one or more push notification services 40/42, as illustrated in FIG. 3. The push notification sending unit 221 may obtain telephone numbers and push notification service credentials for individual users from the databases of user information 214 with the assistance of the query unit 216. Alternatively, the client may provide that information to the message sending unit 220. The user credential information is then used to cause one or more push notification services 40/42 to deliver a message to the users.

The message sending unit 210 may also include a text message sending unit 222 that causes text-based messages to be sent to users. The text-based messages could be traditional SMS/MMS messages, or messages that are delivered to users via an OTT messaging service or perhaps a social networking service. Information needed to send such text-based messages to users may also be obtained from the databases of user information 214 of the user information unit 210, or that information may be provided by the client. Here again, the message sending unit can enlist the services of one or more text-based message delivery platforms to actually send the message to users.

The message sending unit 220 may also include an email message sending unit 224 that causes email messages to be sent to users. The email message sending unit 224 may obtain email addresses and other information, such as user names, for individual users from the databases of user information 214 with the assistance of the query unit 216, or that information may be provided by the client. The information is then used to send email messages to users. The email messages may be delivered to users by one or more third party email services.

The message sending unit 220 may also include a telephony sending unit 226 that is responsible for delivering audio messages to users via a telephony system. For example, the telephony sending unit 226 could generate an audio recording of a message that is to be delivered to users, or the telephony sending unit 226 could receive such an audio message directly from the client. The telephony sending unit 226 would then obtain information about individual customers from the databases of user information 214 with the assistance of the query unit 216, such as user telephone numbers and user names, or that information could be provided by the client. The telephony sending unit 226 would then enlist the aid of an outside service to deliver the audio message to users via a traditional or VOIP telephony system.

In some instances, the telephony sending unit 226 could generate and operate interactive voice response (IVR) applications to deliver such audio messages to users. Doing so may allow a user to request and receive information or services in addition to the original audio message. If a user does interact with an IVR application, how the user interacts with the IVR application could also be recorded in the databases of user information 214 as additional information about the user.

The message sending unit 220 further includes an in-application messaging unit 228. The in-application messaging unit 228 is responsible for causing messages to be delivered to a user via a client's software application that it provides to its users. For this reason, the in-application messaging unit 228 can interact with an instantiation of a client's software application that is resident on a user's computing device.

The customer engagement service 50 could coordinate the actions of all of the above-discussed elements to conduct an advertising or information campaign. As noted above, such a campaign typically involves sending multiple messages to users over a period of time. The messages could all be sent via the same message delivery channel, or the campaign could involve sending messages to users via multiple message delivery channels.

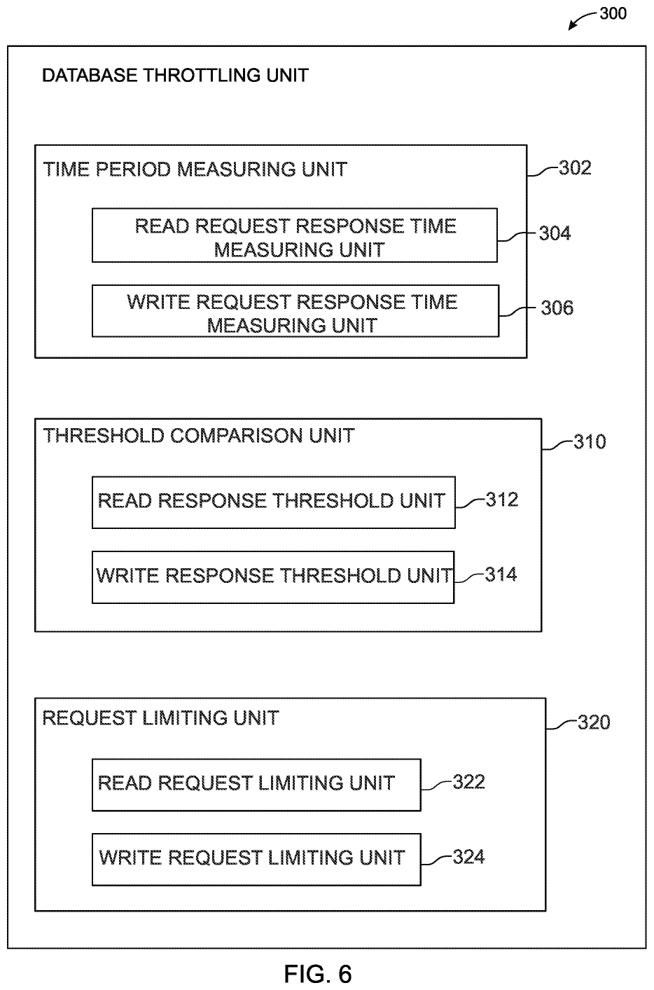

FIG. 6 illustrates selected elements of a database throttling unit 300 which could be a part of a query unit 216 of a customer engagement service 50. While FIG. 6 illustrates one embodiment of the database throttling unit 300, alternate embodiments may have additional elements not shown in FIG. 6. Likewise, some embodiments of a database throttling unit 300 may not have all the elements illustrated in FIG. 6. Thus, the depiction provided in FIG. 6 should in no way be considered limiting of the invention.

The database throttling unit 300 includes a time period measuring unit 302 that measures the amount of time that a database requires to perform one or more operations. As mentioned above, two of the time periods that can be measured to provide an indication of when a database is becoming overloaded is the time required to perform a data read operation and the time required to perform a data write operation. In the embodiment illustrated in FIG. 6, the time period measuring unit 302 includes a read request response time period measuring unit 304 and a write request response time measuring unit 306 which separately track the time required for a database to accomplish read and write operations, respectively. In other embodiments, the time required for a database to perform other types of operations might also be measured.

When a database is operating efficiently, the amount of time the database requires to perform a certain operation will fall within known boundaries. Those boundaries may be generally known to those of skill in the art. Also, it is possible to do real-world testing of an existing database to determine what those boundaries would be for various different types of operations.

Regardless of how they are set, the boundaries are typically expressed as one or more threshold time periods. For example, if we normally expect a database to respond to a read request within 100 milliseconds when the database is lightly loaded, we could set a first threshold time period for accomplishing read requests at 120 milliseconds. If the time the database requires to accomplish a read request exceeds the 120 millisecond read threshold time period, that would be an indication that the database is becoming overloaded. At which point throttling could be applied to limit the number of read requests that are being submitted to the database per unit of time. Similarly, if throttling has already been applied to limit the number of read requests that are being submitted to a database per unit of time, and a check of database performance indicates that the database is responding to each read request in less than the 120 millisecond read threshold time period, then the throttling could be removed or relaxed to allow a larger number of read requests to be submitted to the database per unit of time.

The database throttling unit 300 includes a threshold comparison unit 310, which compares a current measure of how long a database is taking to perform a certain operation, as measured by the time period measuring unit 302, to a corresponding threshold time period to determine if the actual time taken by the database to perform the operation exceeds the threshold time period. If so, throttling would be applied. If not, no throttling would be necessary.

In the embodiment illustrated in FIG. 6, the threshold comparison unit 310 includes a read response threshold unit 312 that compares the time currently required by the database to perform a read operation, as measured by the read request response time measuring unit 304, to a read request threshold time period. Likewise, the threshold comparison unit 310 also includes a write response threshold unit 314 that compares the time required by the database to perform a write operation, as measured by the write request response time measuring unit 306, to a write request threshold time period. If the time period measuring unit 302 measures the time required for a database to perform other types of operations, then there likely would be corresponding operation response threshold units that are part of the threshold comparison unit 310

The database throttling unit 300 further includes a request limiting unit 320 that limits the number of requests that are submitted to the database per unit of time. The request limiting unit 320 can include a read request limiting unit 322 that limits the number of read requests that are submitted to the database per unit of time. The request limiting unit 320 can also include a write request limiting unit 324 that limits the number of write requests that are submitted to the database per unit of time. However, in some embodiments there may be no distinction between read requests or write requests in terms of limiting the number of requests that are submitted to the database per unit of time. Regardless of whether submission of read requests or submission of write requests is overloading the database, the threshold comparison unit 310 will determine when the database is becoming overloaded, and throttling is then applied by the request limiting unit 320 to try to cure the overloading condition. Similarly, when the threshold comparison unit 310 determines that a database is no longer overloaded, the request limiting unit 320 could remove or relax a limit on the number of requests that are being submitted to the database per unit of time.

As mentioned above, the request queue 232 of a query unit 216 of a customer engagement service could include separate queues for data read requests and data write requests. In that instance, the read request limiting unit 322 could limit the number of read requests in a read request queue that are submitted to a database per unit of time. Similarly, the write request limiting unit 324 could limit the number of write requests in a write request queue that are submitted to a database per unit of time.

The semaphore unit 234 of the query unit 216 of the customer engagement service could track and adjust, for each database of user information, the number of read requests per unit of time that can be submitted to a database without causing the database to become overloaded. Similarly, the semaphore unit 234 could track and adjust, for each database of user information, the number of write requests per unit of time that can be submitted to a database without causing the database to become overloaded. In that instance, when the threshold comparison unit 310 determines that a database is taking longer than a threshold time period to accomplish one or more types of operations, the request limiting unit 320 could consult with the semaphore unit 234 to determine an appropriate limit to impose on the number of requests per unit of time that are being submitted to the database.

The semaphore unit 234 could track and adjust separate limits for individual types of database operations, such as a first limit for read operations and a second limit for write operations. Likewise, the semaphore unit 234 could track and adjust various different types of request limits for different databases such that each individual database of user information has different request limits.

Of note here is the fact that the semaphore unit 234 is not simply recording for each database a first limit for read operations and a second limit for write operations which are applied under all circumstances. Instead, the semaphore unit 234 is configured to dynamically adjust the read and write operation limits for individual databases based on the real world conditions being experienced by the databases.

For example, on a first given day, the semaphore unit 234, using input from the time period measuring unit 320, could determine that the read request response time for a first database of user information becomes unacceptably long when more than 150 data read requests per second are submitted to the first database. With that input, the semaphore unit 234 could establish a limit of 145 read requests per second for that first database. However, during a second day, the semaphore unit 234, using input from the time period measuring unit 320, could determine that the time period for the first database to respond to read requests only becomes unacceptably long when 180 read requests per second are submitted to the first database. As a result, the semaphore unit 234 could adjust the limit for read requests for the first database upward to 175 read requests per second. This same concept applies for setting and adjusting data write request limits for individual databases. Thus, the actual read and write request limits for individual databases that are being maintained and supplied by the semaphore unit 234 can vary over time depending on real-world measured conditions.

The times at which the semaphore unit 234 adjusts data read request limits and data write request limits for a database can vary depending on circumstances. For a first database, the semaphore unit 234 could be configured to check and adjust the read and write request limits for the first database on an hourly basis. For a second database, the semaphore unit 234 could check and adjust the data read and write request limits for the second database on a daily basis. System administrators could have the ability to selectively vary how often the semaphore unit checks and adjust data read and write request limits for individual databases.

In some embodiments, the semaphore unit 234 could be configured to monitor how the read and write request limits for individual databases vary over an extended period of time. Based on that analysis, the semaphore unit 234 itself could automatically adjust how frequently the read and write request limits are checked and adjusted for individual databases. For example, if a long term analysis shows that the read and write request limits for a first database only vary slightly from hour to hour, but vary significantly from day to day, then the semaphore unit 234 could configure itself to thereafter check and adjust the read and write request limits for the first database on a daily basis. Similarly, if a long term analysis indicates that the read and write request limits for a second database vary considerably from hour to hour, the semaphore unit 234 could configure itself to check and adjust the read and write request limits for the second database on an hourly basis.

This flexibility in the establishment and imposition of read and write request limits for individual databases ensures that the query unit 216 of a customer engagement service 50 can obtain data from and write data to a database of user information as rapidly as possible, given current conditions. And that, in turn, ensures the customer engagement service can maximize the speed at which messages are sent to users with the data obtained from user databases.

Also of note here is that a database of user information is not responsible for determining and imposing its own limits on the number or data read and write requests it will handle per unit of time. Instead, separate elements of the customer engagement service 50, in the form of the semaphore unit 234 and the database throttling unit 300 are responsible for setting and adjusting the read and write request units for the database.

Also, in the embodiments described immediately above, the semaphore unit 234 uses input from the time period measuring unit 320 of a database throttling unit 300 to set and adjust the data read and write limits for a database. In alternate embodiments, the semaphore unit 234 could use input from other elements of the customer engagement service 50 to help set and adjust the data read and write request limits for individual databases. Also, the semaphore unit 234 could be configured to perform its own testing and analysis, such as the long term monitoring of how read and write limits vary for a database over time discussed above, in order to help set and adjust the data read and write request limits for a database.

In some embodiments, the time required for a database to perform a certain type of operation is compared to only a single threshold time period to reach a conclusion about whether the database is becoming overloaded with queries or data requests. In other instances, a time period that a database requires to perform a certain type of operation may be compared to multiple different threshold time periods to determine an appropriate limit to impose on the number of requests being submitted to the database per unit of time to cure or alleviate overloading. In still other embodiments, the time periods required for a database to perform multiple different types of operations may be compared to multiple respective threshold time periods to determine if the database is becoming overloaded, and also to help identify an appropriate limit to impose on the number of requests being submitted to the database per unit of time to cure or alleviate the overloading. Details about this process are discussed in greater detail below.

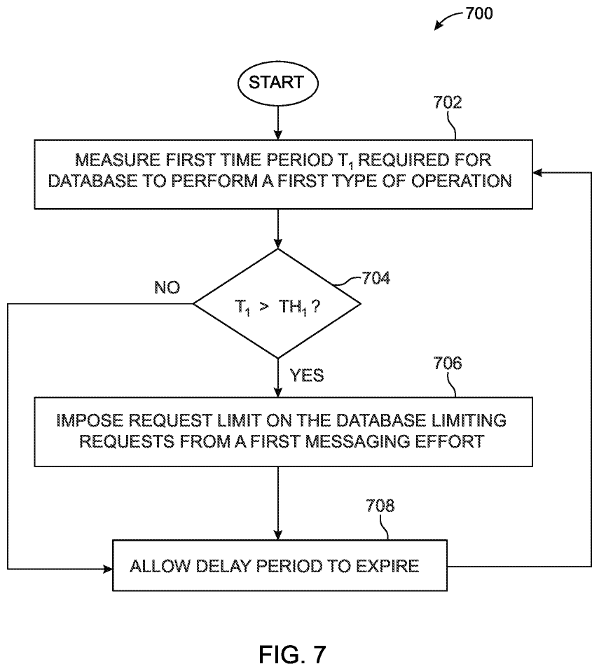

FIG. 7 illustrates steps of a first method 700 of controlling a data read/write request load placed on a database by at least one messaging effort. The method begins and proceeds to step 702, where a time period measuring unit 302 of a database throttling unit 300 measures a first time period T₁ that is required for a database to perform a first type of operation. Next, in step 704, a threshold comparison unit 310 of the database throttling unit 300 determines whether the first time period T₁ is greater than a first threshold time period TH₁.

If the first time period T₁ is not greater than the first threshold time period TH₁, indicating that the database is not being overwhelmed by data read requests and/or data write requests, then the method jumps to step 608 and a delay period is allowed to expire. The delay period is built in to prevent request limits from being rapidly imposed and removed. In other words, the check to determine if the database is taking longer than expected to perform a certain type of operation is performed on a periodic basis. Any application or removal of throttling that is necessary in light of the result of the check is likewise only applied on a periodic basis. Once the delay period expires, the method returns to step 602, and continues as described above and below until the database ceases operations, or possibly until a messaging effort ceases.

If the first time period T₁ is greater than the first threshold time period TH₁, which indicates that the database is becoming overwhelmed with data read and/or write requests, then the method proceeds to step 706 and a request limiting unit 320 of the database throttling unit 300 imposes a first request limit on the database which limits the number of requests per unit of time that a first messaging effort can submit to the database. As explained above, the first request limit can be imposed using the services of a semaphore unit 234 of a query unit 216 of a customer engagement service 50 that is performing the messaging effort.

Next, in step 708, a delay period is allowed to expire. Here again, the delay period is inserted to prevent throttling from being quickly applied and removed. Once the delay period expires, the method returns to step 702, and steps 702-708 are continuously repeated until the database ceases operations, or possibly until the messaging effort ceases.

Step 702 for measuring a time period T₁ required for a database to perform a first type of operation can be accomplished in multiple different ways. For example, when it is time to perform step 702, the time required for the database to perform the next instance of a particular type of operation could be measured and used in step 704 to compare the time period to a threshold time period. In alternate embodiments, monitoring software could measure the time required for the database to respond to each of multiple requests to perform the certain type of operation over a monitoring time period. The monitoring software could then calculate the average time period that the database required to perform that type of operation during the monitoring time period.

The request limit that is imposed in step 706 also could be performed in multiple different ways. Typically, until a request limit is imposed on a database, the database is allowed to receive an unlimited number of requests per unit of time. Requests submitted to the database are only throttled when the database's response times begin to become too long.

The request limit that is imposed on a database could be a strict numerical limit, such as limiting the requests submitted to the database to 100 requests per second. Alternatively, the request limit that is imposed could be defined as a percentage of the current number of requests per unit of time that are being submitted to the database. For example, step 706 could comprise reducing the number of requests per unit of time to 75% of the requests per unit of time that are presently being submitted to the database.

The concepts outlined above about how to measure the time required for a database to perform a certain type of an operation and as to how request limits are imposed apply to all of the methods disclosed and discussed herein, not just the method discussed above in connection with FIG. 7.

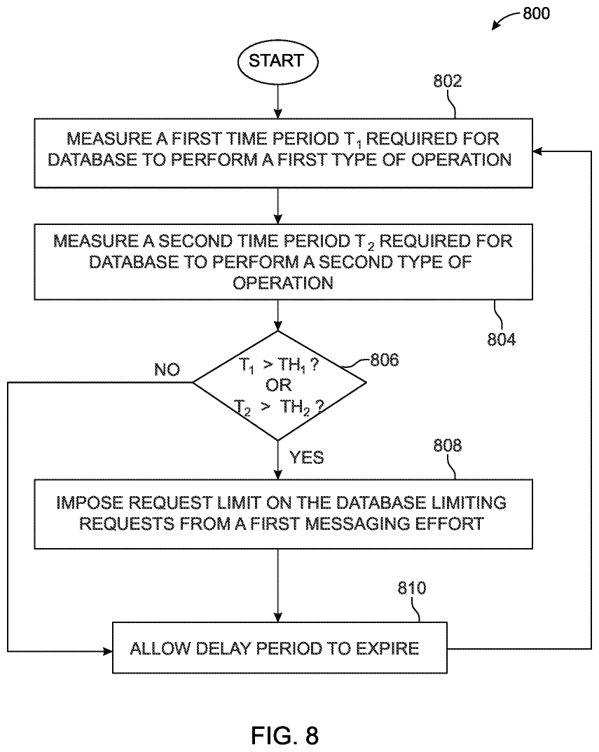

In the method described above in connection with FIG. 7, a decision about whether to impose a query limit on a database is based upon whether a first time period required for the database to perform a first type of operation exceeds a first threshold value. In an alternate method depicted in FIG. 8, the decision about whether to impose a query limit on the database is based upon two time periods relating to two different types of operations that the database could perform.

The method 800 illustrated in FIG. 8 begins and proceeds to step 802, where a time period measuring unit 302 of a database throttling unit 300 measures a first time period T₁ that is required for a database to perform a first type of operation. Next, in step 804, the time period measuring unit 302 measures a second time period T₂ that is required for the database to perform a second type of operation. As before, the measurements could be for the database to perform a single operation or the time periods T₁ and T₂ could represent the average time periods that the database requires to perform the two different types of operations, as measured over a measuring time period.

In step 806, a threshold comparison unit 310 of the database throttling unit 300 determines whether either the first time period T₁ is greater than a first threshold time period TH₁ or whether the second time period T₂ is greater than a second threshold time period TH₂.

If the first time period T₁ is not greater than the first threshold time period TH₁ and the second time period T₂ is not greater than the second threshold time period TH₂, indicating the database is not being overwhelmed by data read or write requests, then the method jumps to step 810 and a delay period is allowed to expire. Once the delay period expires, the method returns to step 802, and steps 802-810 are continuously repeated until the database ceases operations, or possibly until the messaging effort ceases.

If either first time period T₁ is greater than the first threshold time period TH₁ or the second time period T₂ is greater than the second threshold time period TH₂, either of which indicates that the database is becoming overwhelmed with data read and/or write requests, then the method proceeds to step 808 and a query limiting unit 320 of the database throttling unit 300 imposes a request limit on the database which limits the number of requests per unit of time that a first messaging effort can submit to the database. As mentioned above, the first request limit can be imposed using the services of a semaphore unit 234 of a query unit 216 of a customer engagement service 50 that is performing the messaging effort.

Next, in step 810, a delay period is allowed to expire. Once the delay period expires, the method returns to step 802, and steps 802-810 are continuously repeated until the database ceases operations, or possibly until the messaging effort ceases.

In another alternate method 900 as depicted in FIG. 8, both first and second time periods T₁ and T₂ and corresponding first and second threshold time periods TH₁ and TH₂ are used to determine whether to impose a query limit on a database. The method begins and proceeds to step 902, where a time period measuring unit 302 of a database throttling unit 300 measures a first time period T₁ that is required for a database to perform a first type of operation. Next, in step 904, the time period measuring unit 302 measures a second time period T₂ that is required for the database to perform a second type of operation. In step 906, a threshold comparison unit 310 of the database throttling unit 300 determines whether the first time period T₁ is greater than a first threshold time period TH₁ and the second time period T₂ is greater than a second threshold time period TH₂.

If either the first time period T₁ is not greater than the first threshold time period TH₁ or the second time period TH₂ is not greater than the second threshold time period, then the method jumps to step 910 and a delay period is allowed to expire. Once the delay period expires, the method returns to step 902, and steps 902-910 are continuously repeated until the database ceases operations, or possibly until the messaging effort ceases.

If both the first time period T₁ is greater than the first threshold time period TH₁ and the second time period T₂ is greater than the second threshold time period TH₂, indicating that the database is becoming overwhelmed with read and/or write requests, then the method proceeds to step 908 and a query limiting unit 320 of the database throttling unit 300 imposes a request limit on the database which limits the number of requests per unit of time that a first messaging effort can submit to the database. As mentioned above, the request limit can be imposed using the services of a semaphore unit 234 of a query unit 216 of a customer engagement service 50 that is performing the messaging effort.

Next, in step 910, a delay period is allowed to expire. Once the delay period expires, the method returns to step 902, and steps 902-910 are continuously repeated until the database ceases operations, or possibly until the messaging effort ceases.

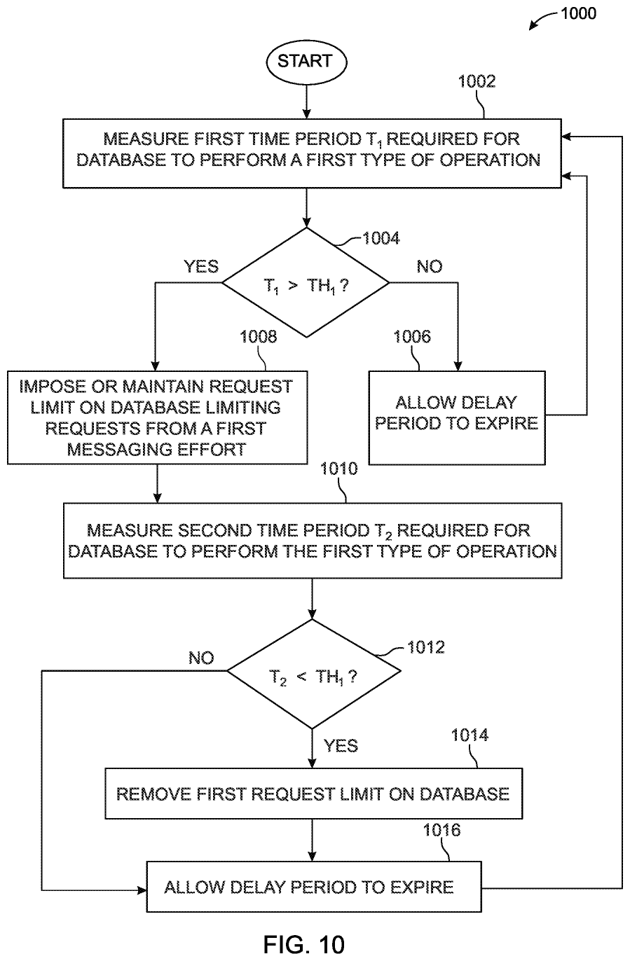

FIG. 10 illustrates steps of a method 1000 of imposing and removing request limits on a database depending on the existing conditions. The method 1000 begins and proceeds to step 1002 where a time period measuring unit 302 of a database throttling unit 300 measures the time T1 that a database requires to perform a first type of operation. Next, in step 1004, a threshold comparison unit 310 compares the time period T₁ to a threshold time period TH₁. If the first time period T₁ is less than the first threshold time period TH₁, indicating the database is not being overwhelmed with data read/write requests, then the method proceeds to step 1006 and a delay period is allowed to expire. The method then loops back to step 1002.

If the first time period T₁ is greater than the first threshold time period TH₁, indicating that the database is becoming overloaded with data read/write requests, then the method proceeds to step 1008 and a request limiting unit 320 imposes a request limit on the database. Thereafter, the method proceeds to step 1010 and the time period measuring unit 302 measures a second time period T₂ required for the database to perform the same type of operation measured in step 1002. Next, in step 1012, the threshold comparison unit 310 compares time period T₂ to the same first threshold time period TH₁. If the second time period T₂ is less than the first threshold time period TH₁, meaning the database is no longer being overloaded with data read/write requests, then the method proceeds to step 1014 and the request limit previously imposed on the database is removed. Thereafter, the method proceeds to step 1016 and a delay period is allowed to expire. Thereafter, the method loops back to step 1002.

If the check performed in step 1012 indicates that second time period T₂ is not less the first threshold time period TH₁, meaning the database is still overloaded with data read and/or write requests, then the method proceeds to step 1016 and a delay period is allowed to expire. Thereafter, the method loops back to step 1002. In a method as depicted in FIG. 10, a request limit can be imposed upon and subsequently removed from a database depending on existing conditions. In an alternate variation of the method depicted in FIG. 10, step 1012 could involve comparing the time required for the database to perform the operation to a second threshold time period TH₂ that is smaller than the first threshold time period TH₁. Operating in this fashion would require that the data read/write request load on the database be significantly lessened before the first request limit previously imposed on the database is removed.

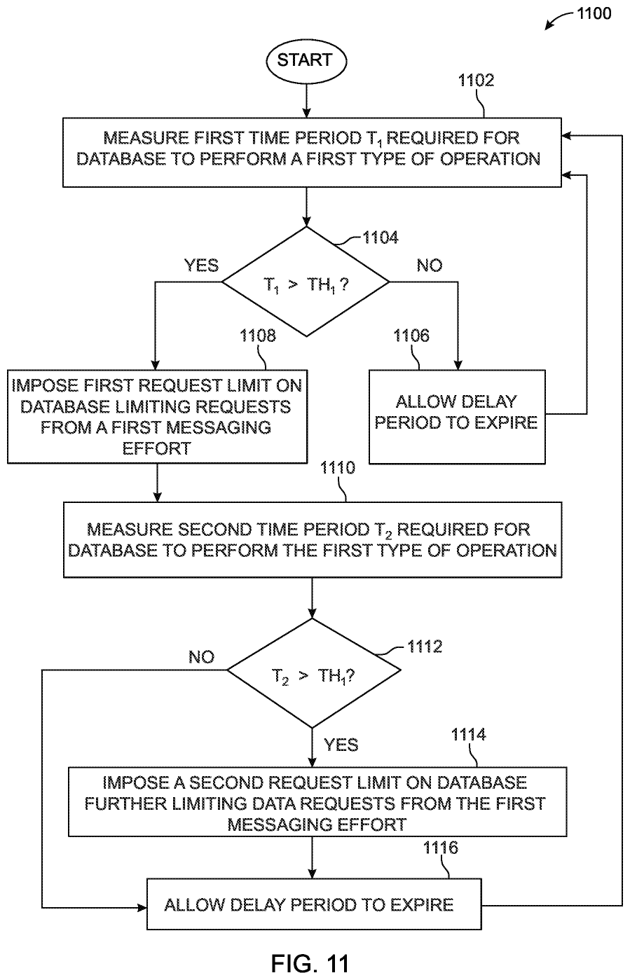

FIG. 11 depicts a method of controlling a load placed on a database where there are two different request limits relating to the same messaging effort that can be imposed on the database. The method 1100 begins and proceeds to step 1102 where a time period measuring unit 302 of a database throttling unit 300 measures a first time period T₁ that is required for a database to perform a first type of operation. Next, in step 1104, a threshold comparison unit 310 of the database throttling unit 300 determines whether the first time period T₁ is greater than a first threshold time period TH₁.

If the first time period T₁ is not greater than the first threshold time period TH₁, indicating the database is not being overwhelmed by data read and/or write requests, then the method jumps to step 1106 and a delay period is allowed to expire. Once the delay period expires, the method returns to step 1102 and proceeds as described above and below.

If the first time period T₁ is greater than the first threshold time period TH₁, indicating that the database is being overwhelmed by data read and/or write requests, then the method proceeds to step 1108 and a request limiting unit 320 of the database throttling unit 300 imposes a first request limit on the database which limits the number of requests per unit of time that a first messaging effort can submit to the database. The first request limit can be imposed using the services of a semaphore unit 234 of a query unit 216 of a customer engagement service 50 that is performing the messaging effort.

Next, in step 1110, the time period measuring unit 302 measures a second time period T₂ that is required for the database to perform the first type of operation. In step 1112, a threshold comparison unit 310 of the database throttling unit 300 determines whether the second time period T₂ is greater than the first threshold time period TH₁. Steps 1110 and 1112 are performed to verify that the first query limit imposed in step 1108 was effective in curing or alleviating the database overload condition. If the second time period T₂ is not greater than the first threshold time period TH₁, indicating that the first query limit imposed in 1108 was effective in curing the overload condition, the method proceeds to step 1116 and a delay period is allowed to expire. After which, the method loops back to step 1102.

If the second time period T₂ is also greater than the first threshold time period TH₁, indicating that the first query limit imposed in step 1108 was not effective in curing the overload condition of the database, the method proceeds to step 1114 and a request limiting unit 320 of the database throttling unit 300 imposes a second request limit on the database which further limits the number of requests per unit of time that a first messaging effort can submit to the database. The second request limit is more stringent than the first request limit to further reduce the number of requests per unit of time that are submitted to the database in the hope that this more stringent second request limit will be effective in curing the database overload condition.

The method then proceeds to step 916 and a delay period is allowed to expire. After which, the method loops back to step 902. The steps of the method are continuously repeated until the database ceases operations, or possibly until the messaging effort ceases.

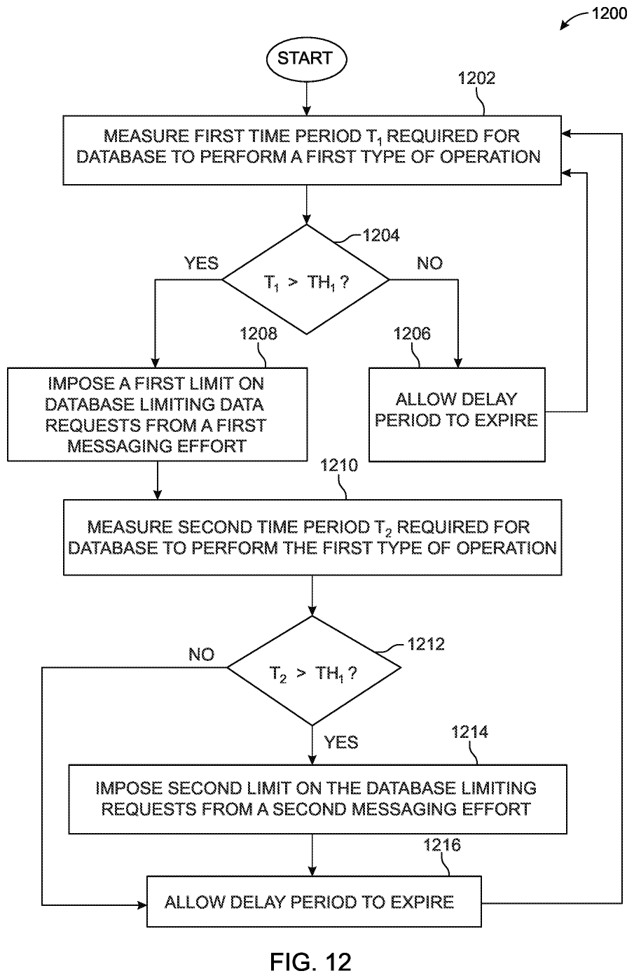

FIG. 12 depicts a method of controlling a load placed on a database where there are two different query limits relating to two different messaging efforts that can be imposed on the database. The method 1200 begins and proceeds to step 1202 where a time period measuring unit 302 of a database throttling unit 300 measures a first time period T₁ that is required for a database to perform a first type of operation. Next, in step 1204, a threshold comparison unit 310 of the database throttling unit 300 determines whether the first time period T₁ is greater than a first threshold time period TH₁.

If the first time period T₁ is not greater than the first threshold time period TH₁, indicating that the database is not being overwhelmed with data read and/or write requests, then the method jumps to step 1206 and a delay period is allowed to expire. Once the delay period expires, the method returns to step 1202 and proceeds as described above and below.

If the first time period T₁ is greater than the first threshold time period TH₁, indicating that the database is being overwhelmed by data read and/.or write requests, then the method proceeds to step 1208 and a query limiting unit 320 of the database throttling unit 300 imposes a first request limit on the database which limits the number of requests per unit of time that a first messaging effort can submit to the database. The first request limit can be imposed using the services of a semaphore unit 234 of a query unit 216 of a customer engagement service 50 that is performing the messaging effort.

Next, in step 1210, the time period measuring unit 302 measures a second time period T₂ that is required for the database to perform the first type of operation. In step 1212, a threshold comparison unit 310 of the database throttling unit 300 determines whether the second time period T₂ is greater than the first threshold time period TH₁. Steps 1210 and 1212 are performed to verify that the first query limit imposed in step 1208 was effective in curing or alleviating the database overload condition.

If the second time period T₂ is not greater than the first threshold time period TH₁, indicating that the first request limit imposed in 1008 was effective in curing the overload condition, the method proceeds to step 1216 and a delay period is allowed to expire. After which, the method loops back to step 1202.

If the second time period T₂ is greater than the first threshold time period TH₁, indicating that the first request limit imposed in step 1208 was not effective in curing the overload condition of the database, the method proceeds to step 1214 and a request limiting unit 320 of the database throttling unit 300 imposes a second request limit on the database which limits the number of requests per unit of time that a second messaging effort can submit to the database. The hope is that a request limit imposed on a second different messaging effort that is also submitting requests to the database will cure or alleviate the database overload condition.

The method proceeds to step 1216 and a delay period is allowed to expire. After which, the method loops back to step 1202. The steps of the method are continuously repeated until the database ceases operations, or possibly until the messaging effort ceases.

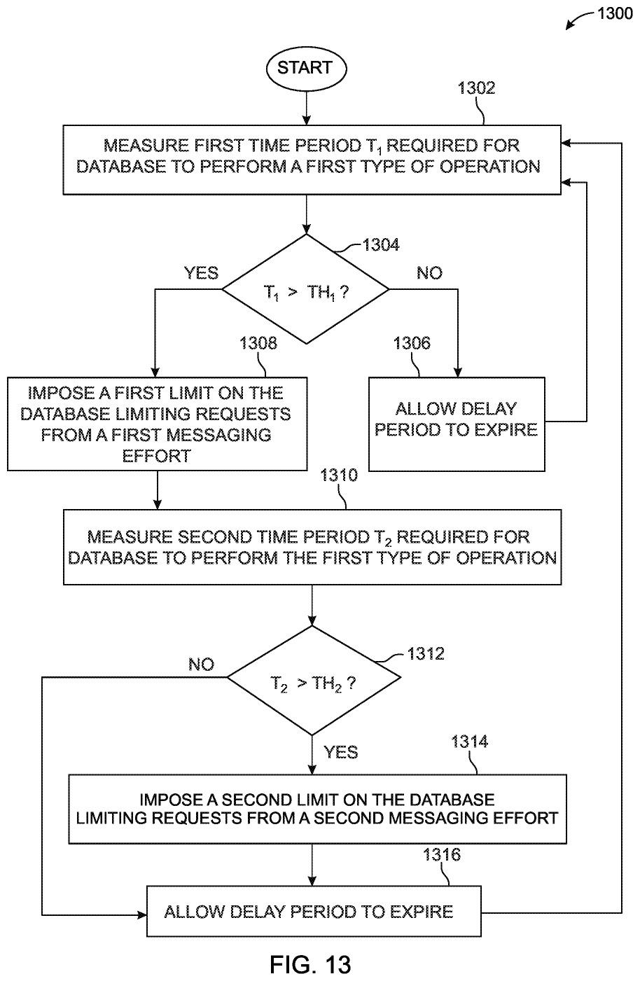

FIG. 13 depicts a method of controlling a load placed on a database where there are two different request limits relating to two different messaging efforts that can be imposed on the database. The method 1300 begins and proceeds to step 1302 where a time period measuring unit 302 of a database throttling unit 300 measures a first time period T₁ that is required for a database to perform a first type of operation. Next, in step 1304, a threshold comparison unit 310 of the database throttling unit 300 determines whether the first time period T₁ is greater than a first threshold time period TH₁.

If the first time period T₁ is not greater than the first threshold time period TH₁, indicating that the database is not being overwhelmed with data read and/or write requests, then the method jumps to step 1306 and a delay period is allowed to expire. Once the delay period expires, the method returns to step 1302 and proceeds as described above and below.

If the first time period T₁ is greater than the first threshold time period TH₁, indicating that the database is being overwhelmed with data read and/or write requests, then the method proceeds to step 1308 and a query limiting unit 320 of the database throttling unit 300 imposes a first request limit on the database which limits the number of requests per unit of time that a first messaging effort can submit to the database. The first request limit can be imposed using the services of a semaphore unit 234 of a query unit 216 of a customer engagement service 50 that is performing the messaging effort.

Next, in step 1310, the time period measuring unit 302 measures a second time period T₂ that is required for the database to perform the first type of operation. In step 1312, a threshold comparison unit 310 of the database throttling unit 300 determines whether the second time period T₂ is greater than a second threshold time period TH₂. The second threshold time period could be longer in duration or shorter in duration than the first threshold time period TH₁. Steps 1310 and 1312 are performed to verify that the first request limit imposed in step 1308 was effective changing the overload condition of the database.

If the second time period T₂ is not greater than the second threshold time period TH₂, indicating that the first query limit imposed in 1008 had the desired effect, the method proceeds to step 1316 and a delay period is allowed to expire. After which, the method loops back to step 1302.

If the second time period T₂ is greater than the second threshold time period TH₂, indicating that the first query limit imposed in step 1108 did not have the desired effect, the method proceeds to step 1314 and a query limiting unit 320 of the database throttling unit 300 imposes a second request limit on the database which limits the number of requests per unit of time that a second messaging effort can submit to the database. The hope if that a query limit imposed on a second different messaging effort that is also submitting requests to the database will cure or alleviate the database overload condition.

The method proceeds to step 1316 and a delay period is allowed to expire. After which, the method loops back to step 1302. The steps of the method are continuously repeated until the database ceases operations, or possibly until the messaging effort ceases.

In some of the methods described above, the time required for a database to perform a first type of operation is used to determine if the database is being overwhelmed by data read and/or write requests. In alternate embodiments, respective time periods required for the database to perform two or more different operations could be compared to respective corresponding threshold time periods to determine if the database is being overwhelmed.

Also, in some of the methods described above, a request limit is imposed on only a first type of messaging effort in an attempt to cure a database overload condition. In alternate embodiments, whenever a database is determined to be overloaded with data read and/or write requests, a request limit is imposed such that all requests from all messaging efforts sending requests to the database are reduced.

The above method descriptions are relatively simple ones where a one or only two request limits are imposed upon or lifted from a database depending on how long it is taking for the database to perform one or more types of operations. In more complex methods embodying the invention, a request limit can be carefully increased and decreased in multiple small increments to ensure that the database never becomes overwhelmed with data read and/or write requests. Thus, a request limit could be steadily stepped up a little at a time to help alleviate an overload condition. Likewise, a request limit could be steadily stepped down or reduced a little at a time as database performance steadily improves over time.

The present invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object-oriented programming language, such as JavaScript, Java®, Swift or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

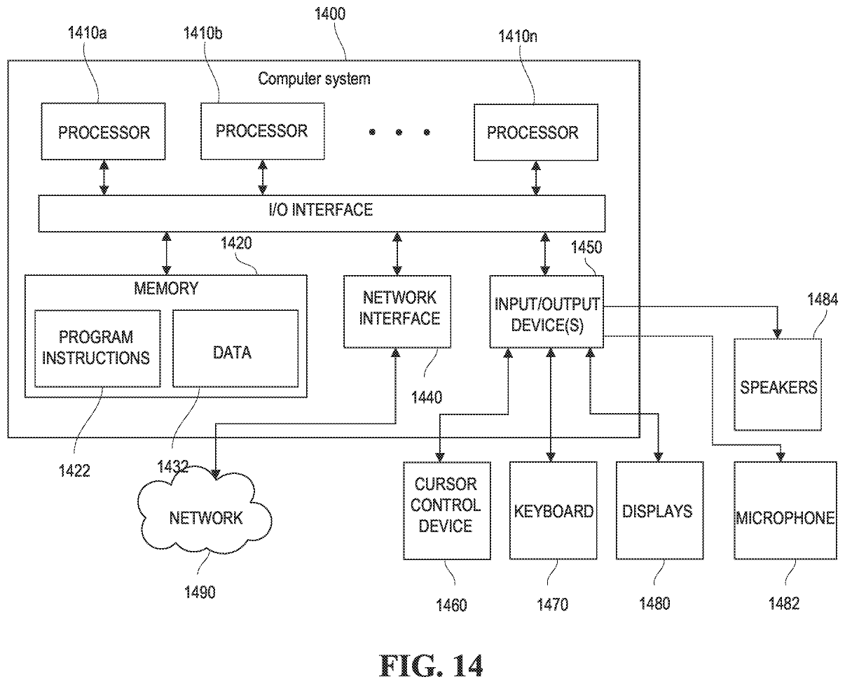

FIG. 14 depicts a computer system 1400 that can be utilized in various embodiments of the present invention to implement the invention according to one or more embodiments. The various embodiments as described herein may be executed on one or more computer systems, which may interact with various other devices. One such computer system is the computer system 1400 illustrated in FIG. 14. The computer system 1400 may be configured to implement the methods described above. The computer system 1400 may be used to implement any other system, device, element, functionality or method of the above-described embodiments. In the illustrated embodiments, the computer system 1400 may be configured to implement the disclosed methods as processor-executable executable program instructions 1422 (e.g., program instructions executable by processor(s) 1410) in various embodiments.

In the illustrated embodiment, computer system 1200 includes one or more processors 1410a-1410n coupled to a system memory 1420 via an input/output (I/O) interface 1430. Computer system 1400 further includes a network interface 1440 coupled to I/O interface 1430, and one or more input/output devices 1450, such as cursor control device 1460, keyboard 1470, display(s) 1480, microphone 1482 and speakers 1484. In various embodiments, any of the components may be utilized by the system to receive user input described above. In various embodiments, a user interface may be generated and displayed on display 1480. In some cases, it is contemplated that embodiments may be implemented using a single instance of computer system 1400, while in other embodiments multiple such systems, or multiple nodes making up computer system 1400, may be configured to host different portions or instances of various embodiments. For example, in one embodiment some elements may be implemented via one or more nodes of computer system 1400 that are distinct from those nodes implementing other elements. In another example, multiple nodes may implement computer system 1200 in a distributed manner.

In different embodiments, the computer system 1400 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 1400 may be a uniprocessor system including one processor 1410, or a multiprocessor system including several processors 1410 (e.g., two, four, eight, or another suitable number). Processors 1410 may be any suitable processor capable of executing instructions. For example, in various embodiments processors 1410 may be general-purpose or embedded processors implementing any of a variety of instruction set architectures (ISAs). In multiprocessor systems, each of processors 1410 may commonly, but not necessarily, implement the same ISA.

System memory 1420 may be configured to store program instructions 1422 and/or data 1432 accessible by processor 1410. In various embodiments, system memory 1420 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1420. In other embodiments, program instructions and/or data may be received, sent or stored upon different types of computer-accessible media or on similar media separate from system memory 1420 or computer system 1400.

In one embodiment, I/O interface 1430 may be configured to coordinate I/O traffic between processor 1410, system memory 1420, and any peripheral devices in the device, including network interface 1440 or other peripheral interfaces, such as input/output devices 1450. In some embodiments, I/O interface 1430 may perform any necessary protocol, timing or other data transformations to convert data signals from one component (e.g., system memory 1420) into a format suitable for use by another component (e.g., processor 1410). In some embodiments, I/O interface 1430 may include support for devices attached through various types of peripheral buses, such as a variant of the Peripheral Component Interconnect (PCI) bus standard or the Universal Serial Bus (USB) standard, for example. In some embodiments, the function of I/O interface 1430 may be split into two or more separate components, such as a north bridge and a south bridge, for example. Also, in some embodiments some or all of the functionality of I/O interface 1430, such as an interface to system memory 1420, may be incorporated directly into processor 1410.

Network interface 1440 may be configured to allow data to be exchanged between computer system 1400 and other devices attached to a network (e.g., network 1490), such as one or more external systems or between nodes of computer system 1400. In various embodiments, network 1490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1450 may, in some embodiments, include one or more display terminals, keyboards, keypads, touchpads, scanning devices, voice or optical recognition devices, or any other devices suitable for entering or accessing data by one or more computer systems 1400. Multiple input/output devices 1450 may be present in computer system 1400 or may be distributed on various nodes of computer system 1400. In some embodiments, similar input/output devices may be separate from computer system 1400 and may interact with one or more nodes of computer system 1400 through a wired or wireless connection, such as over network interface 1440.

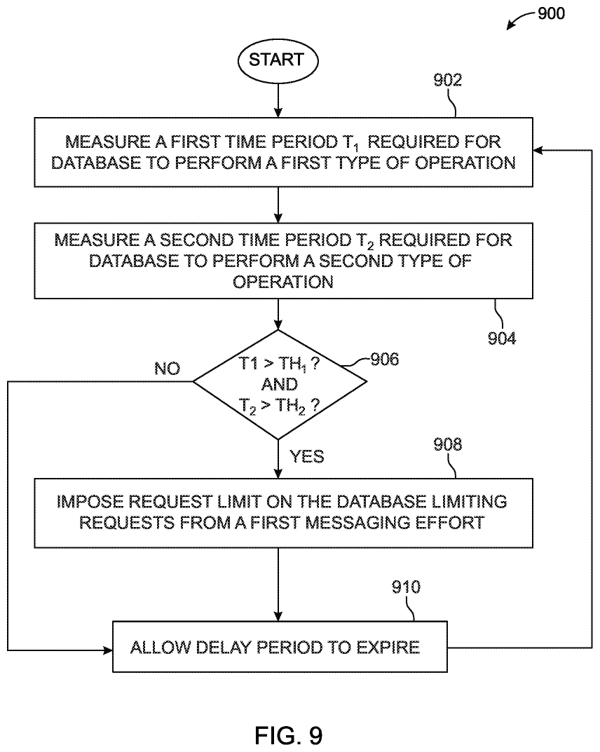

In some embodiments, the illustrated computer system may implement any of the operations and methods described above, such as the methods illustrated by the flowcharts of FIGS. 7-13. In other embodiments, different elements and data may be included.

Those skilled in the art will appreciate that the computer system 1400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 1400 may also be connected to other devices that are not illustrated, or instead ay operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1400 may be transmitted to computer system 1400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of controlling a load placed on a database of customer information by at least one messaging effort; comprising:
measuring a first time period that is required for the database to perform a read operation;
measuring a second time period that is required for the database to perform a write operation;
determining whether the first time period is greater than a first threshold time period;
determining whether the second time period is greater than a second threshold time period; and
imposing a first request limit on the database that limits the number of requests per unit of time that can be submitted to the database when either the first time period is greater than the first threshold time period or the second time period is greater than the second threshold time period.

2. The method of claim 1, further comprising:
measuring, after the first request limit has been imposed, a third time period that is required for the database to perform a read operation;
determining whether the third time period is greater than the first threshold time period; and
imposing a second request limit on the database that limits the number of requests per unit of time that can be submitted to the database when the third time period is greater than the first threshold time period, and wherein the second request limit results in fewer requests per unit of time being submitted to the database than is allowed by the first request limit.

3. The method of claim 1, wherein the first request limit limits the number of requests that a first messaging effort can submit to the database, the method further comprising:
measuring, after the first request limit has been imposed, a third time period that is required for the database to perform a read operation;
determining whether the third time period is greater than the first threshold time period; and
imposing a second request limit on the database that limits the number of requests per unit of time that a second messaging effort can submit to the database when the third time period is greater than the first threshold time period.

4. The method of claim 1, wherein the first query limit limits the number of requests that a first messaging effort can submit to the database per unit of time, the method further comprising:
determining whether the first time period is greater than a third threshold time period that is longer in duration than the first threshold time period; and
imposing a second query limit on the database that limits the number of requests per unit of time that a second messaging effort can submit to the database when the first time period is greater than the third threshold time period.

5. The method of claim 1, wherein the first query limit is imposed using a semaphore technique.

6. The method of claim 5, where the semaphore technique limits the number of data read requests that can be submitted to the database per unit of time based on a read request limit that has been established for the database, and where the data read request limit for the database is variable.

7. The method of claim 6, wherein the data read request limit for the database varies based on the real-world conditions currently being experienced by the database.

8. The method of claim 6, wherein the data read request limit for the database is adjusted based on one or more tests of how rapidly the database is currently performing a read request operation.

9. The method of claim 5, where the semaphore technique limits the number of data write requests that can be submitted to the database per unit of time based on a variable write request limit that has been established for the database based on one or more tests of how rapidly the database is currently performing a data write operation.

10. The method of claim 5, wherein requests that are to be submitted to the database are entered into a first-in first-out queue for submission to the database and wherein a request in the queue is submitted to the database only when the semaphore technique indicates that the database can receive and process a new request.

11. (canceled)

12. The method of claim 1, wherein the first request limit is imposed on the database only when both the first time period is greater than the first threshold time period and the second time period is greater than the second threshold time period.

13. The method of claim 1, further comprising:
measuring, after the first request limit has been imposed, a third time period that is required for the database to perform a read operation;
determining whether the third time period is greater than a third threshold time period; and
removing the first request limit when the third time period is not greater than the third threshold time period.

14. The method of claim 13, wherein the third threshold time period is equal to the first threshold time period.

15. The method of claim 13, wherein the third threshold time period is smaller in duration than the first threshold time period.

16. A system for controlling a load placed on a database of customer information by at least one messaging effort; comprising:
a memory; and
at least one processor configured to perform a method comprising the steps of:
measuring a first time period that is required for the database to perform a read operation;
measuring a second time period that is required for the database to perform a write operation;
determining whether the first time period is greater than a first threshold time period;
determining whether the second time period is greater than a second threshold time period; and
imposing a first request limit on the database that limits the number of requests per unit of time that can be submitted to the database when either the first time period is greater than the first threshold time period or the second time period is greater than the second threshold time period.

17. The system of claim 16, wherein the first query limit is imposed using a semaphore technique, and wherein the semaphore technique limits the number of data read requests or data write requests that can be submitted to the database per unit of time based, respectively, on a read request limit or a write request limit that has been established for the database, and where the data read request limit and the data write request limit for the database are variable.

18. The system of claim 17, wherein the data read request limit and the data write request limit for the database vary based on the real-world conditions currently being experienced by the database.

19. The system of claim 17, wherein the data read request limit for the database is adjusted based on one or more tests of how rapidly the database is currently performing a read request operation.

20. The system of claim 17, wherein the data write request limit for the database is adjusted based on one or more tests of how rapidly the database is currently performing a write request operation.

21. (canceled)

22. (canceled)

23. A method of controlling a load placed on a database of customer information by at least one messaging effort; comprising:
measuring a first time period that is required for the database to perform a read operation;
measuring a second time period that is required for the database to perform a write operation;
determining whether the first time period is greater than a first threshold time period;
determining whether the second time period is greater than a second threshold time period;
imposing a first request limit on the database that limits the number of requests per unit of time that can be submitted to the database asking the database to perform a read operation when the first time period is greater than the first threshold time period; and
imposing a second request limit on the database that limits the number of requests per unit of time that can be submitted to the database asking the database to perform a write operation when the second time period is greater than the second threshold time period.

24. (canceled)
